(19) United States
(12) Patent Application Publication
(10) Pub. No.: US 2007/0017771 A1
(43) Pub. Date: Jan. 25, 2007

(54) Rotating machine having electro-magnetic clutch

(75) Inventors: Hiroki Ishii, Nishio-shi (JP); Mikio Matsuda, Nishio-shi (JP); Hiroshi Kishita, Nishio-shi (JP); Yasuo Tabuchi, Toyoake-city (JP); Motohiko Ueda, Okazaki-city (JP)

Correspondence Address: POSZ LAW GROUP, PLC, 12040 SOUTH LAKES DRIVE, SUITE 101, RESTON, VA, 20191, US

(73) Assignees: NIPPON SOKEN, INC., Nishio-shi (JP); DENSO CORPORATION, Kariya-city (JP)

(21) Appl. No.: 11/488,121

(22) Filed: Jul. 18, 2006

(30) Foreign Application Priority Data
Jul. 20, 2005 (JP) 2005-210131

(51) Int. Cl. F04B 27/08; F16D 27/112

(52) U.S. Cl. 192/84.961

(57) ABSTRACT

A rotating machine having an electro-magnetic clutch includes: a leakage magnetic flux path formed between the electro-magnetic clutch and a housing via the rotary shaft when a portion of the magnetic flux generated by the electro-magnetic clutch leaks out; a Hall-effect IC, which is arranged in the leakage magnetic flux path, for detecting an amount of the leakage magnetic flux passing in the Hall-effect IC; a variable leakage magnetic flux portion which composes a portion of the leakage magnetic flux path and is rotated by the rotary shaft; and an ECU for detecting a state of rotation of the rotating machine from a change in the leakage magnetic flux detected by the Hall-effect IC.

### BACKGROUND OF THE INVENTION

1. Field of the Invention

The present invention relates to a rotating machine, having an electro-magnetic clutch, such as a compressor which receives torque from a prime mover via the electromagnetic clutch. More particularly, the present invention relates to a rotation detecting mechanism for detecting a lock up caused in a rotating machine.

2. Description of the Related Art

A vehicle is provided with a compressor which is a part of an air-conditioning system or a refrigerating system. The power source of this compressor is an engine, the rotating power of which is transmitted to the compressor via a belt. Therefore, when trouble develops in the compressor and the compressor is stopped by being locked up, the belt slips on the pulley of the compressor and breaks, due to the generated heat, in the worst case. Accordingly, it becomes impossible to transmit the engine rotation to other devices.

Therefore, the compressor includes a means for detecting that the compressor has locked up. This lock-up-detecting means judges that the compressor is in a state of lock up in the case where a rotation of the compressor is not detected even when an electro-magnetic clutch is being energized. Concerning the means for detecting that the compressor is rotating, a technique disclosed in the following patent document is well known.

The official gazette of JP-A-59-231226 discloses the following technique. A leakage of magnetic flux, which is generated at the time of energizing an exciting coil, forms a bypass magnetic path passing through a rotary shaft of the compressor, and a magnetic sensor, which is affected by this bypass magnetic path, is provided. This bypass magnetic path has a magnetic member penetrating a boss portion which covers the rotary shaft. The magnetic force in the bypass magnetic path is changed by this magnetic member and a change in the air gap caused by a change in the shape (key seat) of a rotary shaft. Due to a change in the output of the magnetic sensor caused by this change in the magnetic force of the bypass magnetic path, rotation of the compressor can be detected.

The official gazette of JP-A-6-299960 discloses the following technique. A leakage of magnetic flux, which leaks from an electro-magnetic clutch, is successively continued in a rotary shaft, a movable member rotating together with the rotary shaft and a fastener for fastening the device body so as to form a circulating magnetic circuit. By a periodic motion of the rotating member, a change in the magnetic flux is generated in the fastener. At the same time, a change in the magnetic flux is detected by a detector attached to an outside portion in the magnetic circuit. According to the result of the detection, the rotating speed of the compressor can be detected.

However, according to the technique disclosed in the official gazette of JP-A-59-231226, it is necessary for the magnetic member to penetrate the boss portion. Accordingly, the following problems may be encountered. The mechanical strength of the boss portion is lowered and the manufacturing cost is raised. Further, the magnetic sensor itself can becomes a cause of raising the manufacturing cost.

According to the technique disclosed in the official gazette of JP-A-6-299960, although it is unnecessary to machine the compressor, the detector utilizes a coil. Therefore, the coil and the fastener compose an antenna. Accordingly, the detector is likely to be affected by noise.

### SUMMARY OF THE INVENTION

In order to raise the detection voltage, it is necessary to increase the number of turns of the coil. Further, it is necessary to arrange another magnetic body such as a magnet. Therefore, problems may be encountered and, for example, a size of the detector is increased and the manufacturing cost is raised. The present invention has been accomplished to solve the above problems of the prior art. An object of the present invention is to provide a compact and highly accurate rotating machine having an electro-magnetic clutch with a low-cost rotation detecting mechanism for detecting the rotating state of the rotating machine.

In order to accomplish the above object, the technical means of the first to twelfth aspects of the present invention are employed. That is, according to a first aspect of the present invention, there is provided a rotating machine having an electromagnetic clutch, which is a rotating machine (40), the rotary shaft (48) of which receives torque from a prime mover (30) via the electro-magnetic clutch (1), comprising:

a leakage magnetic flux path (Φ′) formed between the electro-magnetic clutch (1) and a housing (43) of the rotating machine (40) via the rotary shaft (48) when a portion of the magnetic flux generated by the electro-magnetic clutch (1) leaks out;

a Hall-effect IC (22a), which is arranged in the leakage magnetic flux path (Φ′), for detecting an amount of the leakage magnetic flux passing-through the Hall-effect IC (22a);

a variable leakage magnetic flux portion (52) which composes a portion of the leakage magnetic flux path (I′) and is rotated by the rotary shaft (48); and

a rotation, detecting means (20) for detecting a state of rotation of the rotating machine (40) from a change in the leakage magnetic flux detected by the Hall-effect IC (22a)

In this constitution, a rotating state of the rotating machine (40) is detected by detecting a change in the leakage magnetic flux, using the Hall-effect IC (22a) provided between the magnetic clutch (1) and the housing (43). According to this first aspect, it is unnecessary to conduct machining to provide an object of detection. Therefore, the device can be downsized as compared with a conventional detector in which a coil is used. As the detector is not affected by noise, it is unnecessary to arrange another magnetic body such as a magnet. Therefore, it is possible to obtain a high detection accuracy using a detector, the manufacturing cost of which is low.

According to a second aspect of the present invention, a fastening screw portion (63) for fixing the housing (43) is utilized for forming the leakage magnetic flux path (Φ′) between the electro-magnetic clutch (1) and the housing (43). According to this second aspect, it is unnecessary to form a leakage magnetic flux path (Φ′) portion between the magnetic clutch (1) and the housing (43). Therefore, the manufacturing cost can be reduced.

According to a third aspect of the present invention, the Hall-effect IC (22a) is molded in a resin portion (22b) and formed into a cap-shape, so that the Hall-effect IC (22a) can cover the fastening screw portion (63), and the Hall-effect IC (22a) is pressed and held by the electro-magnetic clutch (1). According to the third aspect, it is unnecessary to provide a holding part for holding a sensor. Therefore, the manufacturing cost can be suppressed. Further, it is possible to protect the Hall-effect IC (22a) from the external environment and from shock.

According to a fourth aspect of the present invention, a magnetic body (22c) is arranged between the Hall-effect IC (22a) and the electro-magnetic clutch (1). According to the fourth aspect, even in the case of a minute change in the leakage of magnetic flux, the detection accuracy can be enhanced.

According to a fifth aspect of the present invention, the Hall-effect IC (22a) and the magnetic body (22c) are molded in the resin portion (22b) and are integrated with each other into one body. According to the fifth aspect, it is possible to stabilize a positional relation between the Hall-effect IC (22a) and the magnetic body (22c). Therefore, the detection accuracy can be stabilized. Further, a plurality of parts are integrated with each other into one body. Therefore the parts can be easily handled, which reduces the manufacturing cost.

According to a sixth aspect of the present invention, a magnetic plate (3b) composing the electro-magnetic clutch (1) is used as the magnetic body (22c). According to the sixth aspect, one member can be used for both the detecting accuracy enhancing member and the holding member. Therefore, the number of parts can be reduced and the manufacturing cost can be suppressed.

According to a seventh aspect of the present invention, the Hall-effect IC (22a) and the electro-magnetic clutch (1) have an electric power source in common. According to the seventh aspect, the number of electric wires, which are laid for the control means (20) and are also used as the rotation detecting means (20), can be reduced. Therefore, the manufacturing cost can be reduced.

According to an eighth aspect of the present invention, the Hall-effect IC (22a) and the power supply line to the electromagnetic clutch (1), which is connected to Hall-effect IC (22a), are molded in the resin portion (22b) and are integrated with each other into one body. According to the eighth aspect, a plurality of parts are integrated with each other into one body. Therefore the parts can be easily handled, which reduces the manufacturing cost.

According to a ninth aspect of the present invention, the resin portion (22b), in which the Hall-effect IC (22a) and the power supply line to the electro-magnetic clutch (1) are molded and integrated with each other into one body, is further integrated, with the electromagnetic clutch (1), into one body by the resin member (3a) of the exciting coil (4) portion of the electro-magnetic clutch (1). According to the ninth aspect, when the electromagnetic clutch (1) is incorporated, the Hall-effect IC (22a) can be also incorporated. Accordingly, handling can be easily done, which reduces the manufacturing cost.

According to a tenth aspect of the present invention, the rotation detecting means (20) judges that the rotating machine is in a state of lock up and the rotation detecting means (20) shuts off a power supply to the electro-magnetic clutch (1) in the case where a predetermined pulsation is not caused in a signal voltage sent from the Hall-effect IC (22a) under the condition that the rotary shaft (48) is to be rotated. According to the tenth aspect, the detected value can be utilized as a rotation detecting mechanism. Further, in the same manner as that of the conventional rotating speed detecting means, by whether or not a detected change in the signal corresponds to the rotating speed, it can be also used as a lock-up-detecting mechanism.

According to an eleventh aspect of the present invention, the rotating machine (40) is a compressor. According to the eleventh aspect, the invention can be preferably used for a lock-up-detecting mechanism of a compressor having an electro-magnetic clutch.

According to a twelfth aspect of the present invention, a lug plate (52) of a swash plate type variable capacity compressor is used for the variable leakage magnetic flux portion (52). In the twelfth aspect, when a change in the distance with respect to the fastening screw portion (63) is provided by utilizing the lug plate (52) in the present invention, a variable leakage magnetic flux portion (52) can be easily formed. By this twelfth aspect, the manufacturing cost can be reduced.

Incidentally, the reference numerals in parentheses, to denote the above means, are intended to show the relationships between the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

FIG. 1 is a schematic illustration showing a model, of a system with respect to a rotation of a compressor 40 in a refrigerating cycle for vehicle use, of an embodiment of the present invention.

FIG. 2 is a sectional view showing an electro-magnetic clutch 1 and a compressor 40 in the first embodiment of the present invention.

FIG. 3 is a partial sectional view of FIG. 2 showing a primary magnetic flux path Φ and a leakage magnetic flux path Φ′.

FIG. 4A is a sectional view taken on line A-A in FIG. 2 showing a state in which a gap formed between a lug plate 52 and a through-bolt 63 is small.

FIG. 4B is a sectional view taken on line A-A in FIG. 2 showing a state in which a gap formed between a lug plate 52 and a through-bolt 63 is large.

FIG. 5A is a graph for explaining a rotation detecting method conducted by a leakage magnetic flux in the first embodiment of the present invention, wherein this graph shows a normal case.

FIG. 5B is a graph for explaining a rotation detecting method conducted by a leakage magnetic flux in the first embodiment of the present invention, wherein this graph shows an abnormal case.

FIG. 6 is a partial sectional view showing an electromagnetic clutch 1 and a compressor 40 in the second embodiment of the present invention.

FIG. 7 is a partial sectional view showing an electro-magnetic clutch 1 and a compressor 40 in the third embodiment of the present invention.

FIG. 8A is an electric circuit diagram of this device, wherein FIG. 8A shows a usual connecting method.

FIG. 8B is an electric circuit diagram of this device, wherein FIG. 8B shows a connecting method in the fourth embodiment of the present invention.

FIG. 9 is a partial sectional view showing an electro-magnetic clutch 1 and a compressor 40 in the fifth embodiment of the present invention.

FIG. 10 is a sectional view taken on line B-B in FIG. 9.

FIG. 11 is an electric circuit diagram in the case where a regulator 64 is interposed in the fourth embodiment.

### DESCRIPTION OF PREFERRED EMBODIMENTS

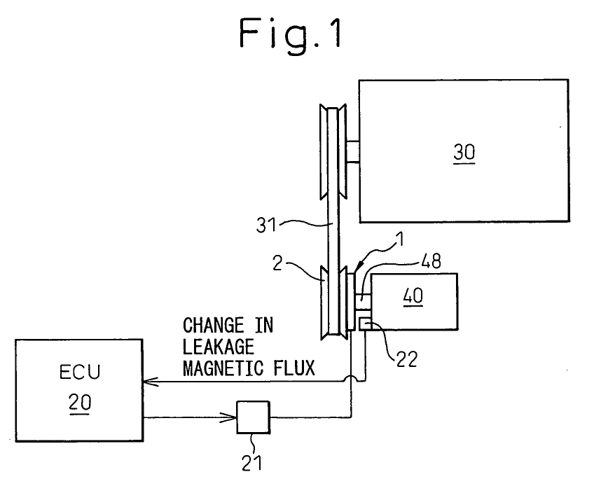

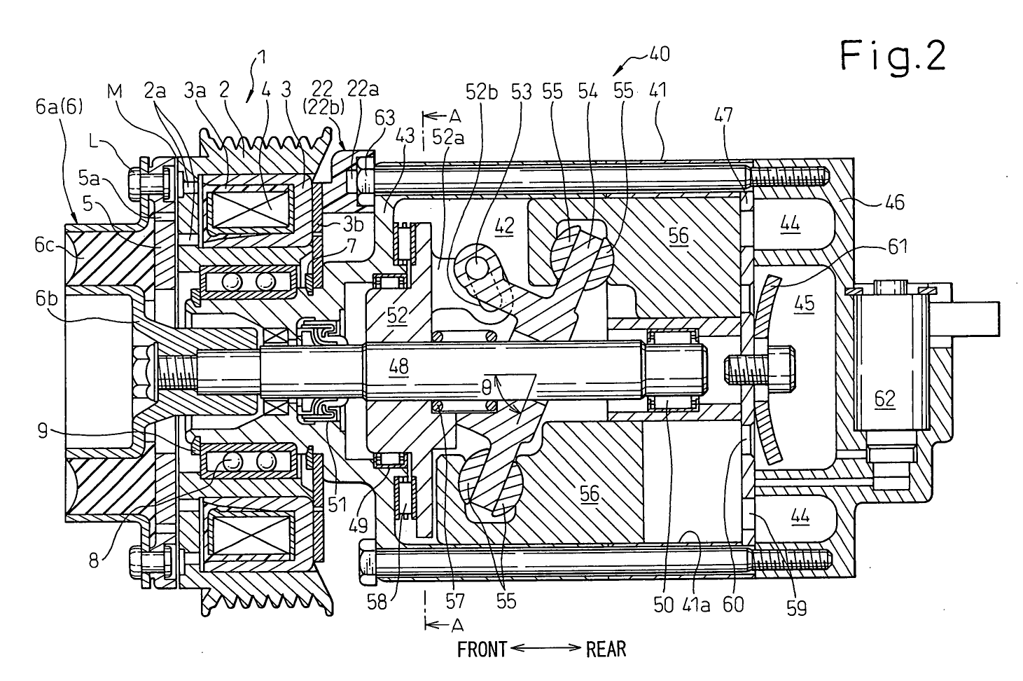

Referring to FIGS. 1 to 5B, a first embodiment of the present invention, which corresponds to claims 1 to 3 and 10 to 12, will be explained below in detail. FIG. 1 is a schematic illustration showing a model of a system, with respect to a rotation of a compressor 40 in a refrigerating cycle for vehicle use, of an embodiment of the present invention. FIG. 2 is a sectional view showing an electro-magnetic clutch 1 and a compressor 40 in the first embodiment of the present invention. First of all, a structure of the electro-magnetic clutch 1 will be explained mainly by referring to FIG. 2. The electro-magnetic clutch 1 is attached to, for example, a rotating machine such as a compressor 40. When necessary, the electro-magnetic clutch 1 transmits torque from an engine 30 (shown in FIG. 1), which is a prime mover, to a rotary shaft 48 of the compressor 40.

The magnetic clutch 1 includes: a stator 3 which is an exciting means and composes a closed magnetic path forming means; an exciting coil accommodated in the stator 3; a rotor 2 which is an input rotary body rotated by the engine 40 and which composes a closed magnetic path forming means; an armature 5 which is an output rotary body attached to the rotor 2 by a magnetic force generated by the exciting coil 4 and which composes a closed magnetic path forming means; and a hub assembly 6 which rotates integrally with the armature 5 and transmits torque to a rotary shaft 48 of the compressor 40.

In the exciting coil 4, a copper wire coated with an insulating coating is wound. This exciting coil 4 is accommodated in a stator 3 made of magnetic material such as iron, the cross-section of which is formed into a C-shape. The exciting coil 4 is fixed in the stator 3 being molded by a resin material 3a such as epoxy. In this connection, the stator 3 is made of a magnetic material such as iron and fixed to a clutch bottom plate 3b which is a ring-shaped plate made of magnetic material. When this clutch bottom plate 3b is fixed to a boss base portion of a front housing, which is referred to as a housing in the present invention, of the compressor 40 by the first circlip 7, the stator 3 can be fixed to the compressor 40.

The rotor 2 includes a pulley portion around which a belt 31 is wound as shown in FIG. 1. The rotor 2 is rotated by rotary power transmitted from the engine 30 via the belt 31. The rotor 2 is made of a magnetic material such as iron. A cross-section of the rotor 2 is formed into a C-shape in which the stator 3 is accommodated. A front side of the rotor 2, in the axial direction, is formed into a smooth friction face M. In the rotor 2, in a portion close to the inner circumference of the friction face M and in a portion close to the outer circumference of the friction face M, long holes 2a, which allow a magnetic path, generated at the time of energizing the exciting coil 4, to detour, are provided almost all over the circumference.

A rolling bearing 8 is provided on an inner circumference of the rotor 2. This rolling bearing 8 pivotally supports the rotor 2 around a boss portion of the front housing 43 to cover a rotary shaft 48 of the compressor 40. An outer ring of the rolling bearing 8 is fixed onto an inner circumference of the rotor 2 and an inner ring of the rolling bearing 8 is attached to an outer circumference of the boss portion of the front housing 43. The inner ring of the rolling bearing 8 is fixed to an outer circumference of the boss portion of the front housing 43 and fixed to the boss portion by the second circlip 9.

An armature 5 is arranged opposed to the friction face M of the rotor 2 while leaving a predetermined gap between the armature 5 and the friction face M. The armature 5 is made of magnetic material such as iron and is formed into a ring shape. A face of this armature 5, which is opposed to the friction face M of the rotor 2, is also formed into the same friction face M. In an intermediate portion of the friction face M of the armature 5, a long hole 5a, which allows a magnetic path generated at the time of energizing the exciting coil 4 to make a detour, is provided almost all over the circumference.

The hub assembly 6 includes: an outer hub 6a fixed to the armature 5; an inner hub 6b fixed to a rotary shaft 48 of the compressor 40; and a cushion rubber member 6c for connecting the outer hub 6a with the inner hub 6b. The outer hub 6a is formed into an annular shape, the cross-section of which is an L-shape, and its disk portion is fixed to the armature 5 by a plurality of rivets L. The inner hub 6b is engaged with the rotary shaft 48 of the compressor 40 by means of spline-engagement and rotated integrally with the rotary shaft 48.

The cushion rubber member 6c is bonded and fixed onto an inner circumferential face of the outer hub 6a and an outer circumferential face of the inner hub 6b. The cushion rubber member 6c is set so that a gap between the friction face M of the rotor 2 and the friction face M of the armature 5 can be maintained at a predetermined value at the time of stopping a supply of electric current to the exciting coil 4. As the cushion rubber member 6c is elastically deformed, the armature 5 can be attached to the rotor 2. At the time of stopping a supply of electric current to the exciting coil 4, by a restoring force of the cushion rubber member 6c, the armature 5 can be returned to an initial position.

Energizing of the exciting coil 4 is controlled by ECU 20 (shown in FIG. 1) which is a control means for controlling the electro-magnetic clutch 1. ECU 20, which is a rotation detecting means and a lock-up-detection means of the present invention, detects a change in the leakage magnetic flux passing through the Hall-effect sensor 22 described later. When ECU 20 detects the occurrence of lock up of the compressor 40 by a change in the leakage magnetic flux, ECU 20 fulfills a function of protecting the device by stopping a supply of electric current to the exciting coil 4. In this connection, ECU 21 controls energizing the exciting coil 4 by controlling a relay 21.

Next, referring to FIG. 2, a structure of the compressor 40 will be explained below. The compressor 40 of this embodiment is a swash plate type variable capacity compressor. Reference numeral 41 shown in FIG. 2 is a cylinder block in which a plurality of cylinder bores are arranged in parallel to each other. A front end of this cylinder block 41 is closed by a front housing 43 in which a crank chamber 42 is formed. A rear end of this cylinder block 41 is closed by a rear housing 46, in which a suction chamber 44 and a discharge chamber 45 are defined, via a valve plate 47.

Reference numeral 48 is a rotary shaft pivotally supported by the front housing 43 and the cylinder block 41 respectively via the radial bearings 49 and 50. In an extending portion of the rotary shaft 48 on the front housing 43 side, a shaft seal (a shaft sealing device) 51 is arranged. The rotary shaft 48 is rotated by the engine 30 being connected to the engine 30 via a pulley 2, which is attached at an end portion of the rotary shaft 48, and a belt 31.

The plurality of cylinder bores 41a are formed on the same circumference at regular intervals between both end portions of the cylinder block 41 so that the plurality of cylinder bores 41a can be located on an axis parallel with the axis of the rotary shaft 48. Inside the cylinder bores 41a, pistons 56 are accommodated and are capable of reciprocating. A lug plate 52, which is a variable leakage magnetic flux portion of the present invention, is arranged in the crank chamber 42 so that it can be rotated integrally with the rotary shaft 48. An arm 52a composing a portion of the hinge mechanism is protruded from the lug plate 52. At a forward end portion of the arm 52a, a long hole 52b composing a portion of the hinge mechanism is formed.

A swash plate 54, the shape of which is formed into a substantial disk, is provided on the rotary shaft 48. In this structure, the rotary shaft 48 is inserted into the swash plate 54 so that an inclination angle of the swash plate 54 with respect to the rotary shaft 48 can be changed and further the swash plate 54 can be slid in the axial direction. On one end face of the swash plate 54, an engaging pin 53 composing a portion of the hinge mechanism is provided. When this engaging pin 53 is oscillatorily engaged in the long hole 52b described before, the swash plate 54 is connected by means of hinge to the lug plate 52 so that the swash plate 54 can be displaced by an inclination angle θ. Further, on an outer circumference of this swash plate 54, a pair of hemispherical shoes are engaged. Through these shoes 55, the swash plate 54 is connected to a piston 56 accommodated in the cylinder bore 41a.

Reference numeral 57 is a coil spring. The coil spring 57 is provided on the rotary shaft 48 between the lug plate 52 and the swash plate 54. Reference numeral 58 is a thrust bearing for receiving a thrust force acting forward on the rotary drive system. The thrust bearing 58 is interposed between thrust bearing surfaces provided on both the inside wall of the front housing 43 and the lug plate 52 opposed to the inside wall of the front housing 43.

When the rotary shaft 48 is rotated by the engine 30, the swash plate 54 is rotated while being inclined via the lug plate 52 and the hinge mechanism, and each piston 56 is reciprocated in the cylinder bore 41a. In this connection, when the inclination angle θ shown in the drawing is decreased, a stroke of the reciprocating piston 56 is reduced. Therefore, a discharge capacity of the pump is decreased.

In this connection, reference numeral 59 is a suction port for communicating the suction chamber 44 with the cylinder bore 41a. Reference numeral 60 is a discharge port for communicating the cylinder bore 41a with the discharge chamber 45. Reference numeral 61 is a discharge valve for preventing fluid from flowing backward from the discharge chamber 45 to the cylinder bore 41a. Reference numeral 62 is a control valve for controlling pressure in the crank chamber 42 by adjusting a state of communication of the crank chamber 42 with the suction chamber 44 and the discharge chamber 45.

Next, a primary portion of this embodiment will be explained as follows. In the present embodiment into which the electro-magnetic clutch 1 and the compressor 40 are incorporated, the Hall-effect IC 22a is provided between the electromagnetic clutch 1 and the front housing 43 and detects a change in the leakage magnetic flux passing through the Hall-effect IC 22a so as to detect a state of rotation of the compressor 40.

The Hall-effect IC 22a is composed in such a manner that a Hall-effect element, which is a magnetic sensor, and a signal processing circuit, which conducts amplifying and discriminating, are integrated into one chip, which is referred to as a Hall-effect sensor. According to the Hall-effect sensor, it is possible to measure a rotating speed or a position by detecting magnetism under the condition of non-contact. Therefore, the Hall-effect sensor is conventionally used for a vehicle speed sensor or a crank angle sensor. In this connection, in this embodiment in which the Hall-effect sensor is used in an engine room, the environmental temperature of which is 120° C. or more, that is, the environmental temperature of which is high, it is common to use IC capable of operating at a high temperature.

An example of IC capable of operating at a high temperature is a Hall-effect IC formed out of GaAs chemical compound semiconductor, the magnetic sensitivity of which is higher than that of Si and the element separation performance at a high temperature of which is excellent. Nowadays, there is provided a GaAs Hall-effect IC capable of conducting a switching operation at a magnetic field intensity not higher than 200 Gauss in a temperature range from −50° C. to 150° C. The linearity of a GaAs Hall-effect element, which is a magnetism detecting section, is excellent in a wide dynamic range. Therefore, GaAs Hall-effect element can be applied to an analogous magnetic sensor.

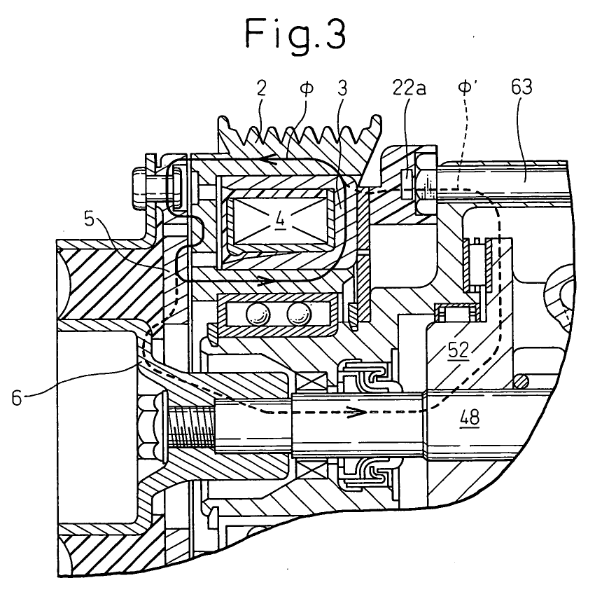

FIG. 3 is a partial sectional view of FIG. 2 showing a primary magnetic flux path Φ and a leakage magnetic flux path Φ′. A magnetic flux generated by the exciting coil 4 forms a primary magnetic flux path Φ of the closed magnetic path in such a manner that stator 3→rotor 2→attached armature 5→rotor 2→stator 3. A portion of the magnetic flux generated by the exciting coil 4 forms one leakage magnetic flux path Φ′ in such a manner that stator 3→rotor 2→armature 5→hub assembly 6→rotary shaft 48→lug plate→through-bolt 63→stator 2.

In the present invention, the above Hall-effect IC 22a is arranged in the leakage magnetic flux path Φ′. More particularly, the Hall-effect IC 22a is molded with resin material such as polyester so as to form a sensor holder portion (a resin portion) 22b. In this way, the Hall-effect sensor 22 can be formed as a whole.

The Hall-effect sensor 22 is held as follows. The sensor holder portion 22b is formed into a cap-shape and is put on a through-bolt 63 which is a screw fastening portion for fastening the housings to each other. An upper face of the Hall-effect sensor 22 is held by the clutch bottom plate 3b of the electromagnetic clutch 1. In this way, the Hall-effect sensor 22 is held. In this structure, the through-bolt 63 is utilized as a portion in which the leakage magnetic flux path Φ′ is formed between the electromagnetic clutch 1 and the front housing 43.

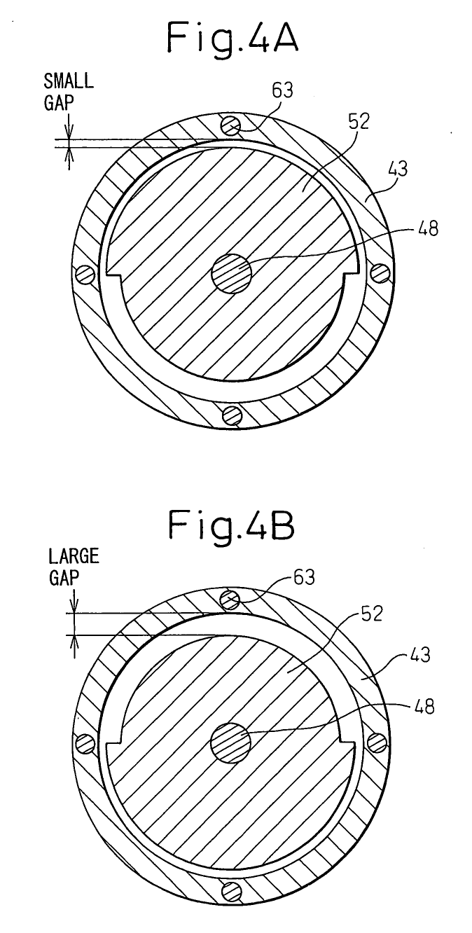

FIG. 4A is a sectional view taken on line A-A in FIG. 2 showing a state in which a gap formed between a lug plate 52 and a through-bolt 63 is small. FIG. 4B is a sectional view taken on line A-A in FIG. 2 showing a state in which a gap formed between a lug plate 52 and a through-bolt 63 is large. In an outline of the lug plate 52, a portion in which a gap with respect to the through-bolt 63 is small and a portion in which a gap with respect to the through-bolt 63 is large are formed so that a leakage magnetic flux can be changed in the through-bolt 63 to which the Hall-effect IC is attached according to a state of rotation of the rotary shaft 48.

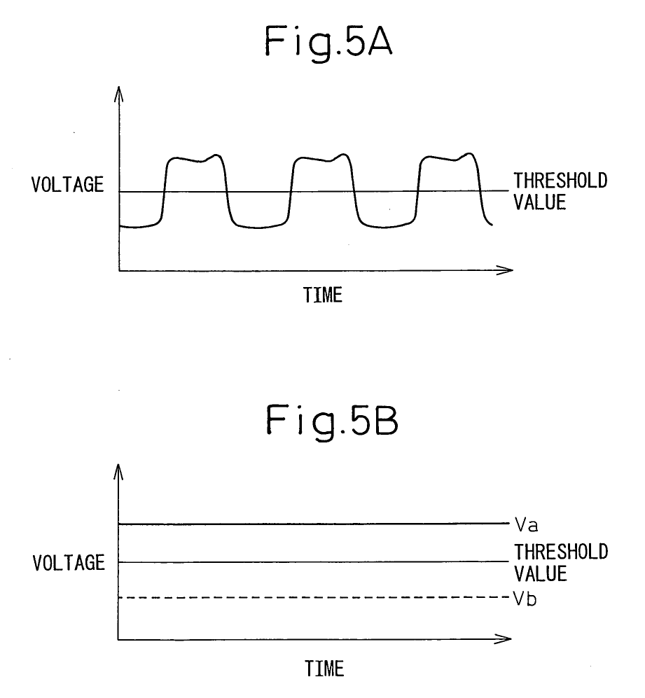

FIG. 5A is a graph for explaining a rotation detecting method conducted by a leakage magnetic flux in the first embodiment of the present invention, wherein this graph shows a normal case. Fig. 5B is a graph for explaining a rotation detecting method conducted by a leakage magnetic flux in the first embodiment of the present invention, wherein this graph shows an abnormal case. When the lug plate 52 is arranged as described above, at the time of normal operation, as shown in FIG. 5A, it is possible to obtain a pulse voltage corresponding to the rotating speed. At the time of abnormal operation, for example, in the case of the occurrence of lock up, as shown in FIG. 5B, the voltage is maintained at a constant value Vₐ which is higher than the threshold value or at a constant value V_{b} which is lower than the threshold value. Therefore, it is impossible to obtain a pulsation of voltage.

Next, characteristics of this embodiment will be explained as follows. First, the present embodiment includes a rotating machine 40, the rotary shaft 48 of which receives torque from the engine 30 via the electro-magnetic clutch 1. The present embodiment further includes: a leakage magnetic flux path Φ′ formed between the electromagnetic clutch 1 and the housing 43 of the rotating machine 40 via the rotary shaft 48 when a portion of the magnetic flux generated in the electro-magnetic clutch 1 leaks out; a Hall-effect IC 22a, which is arranged in the leakage magnetic flux path Φ′, for detecting an amount of magnetic flux passing through; a variable leakage magnetic flux portion 52, which composes a portion of the leakage magnetic flux path Φ′, rotated by the rotary shaft 48; and ECU 20 for detecting a state of rotation of the rotating machine 40 from a change in the leakage magnetic flux detected by the Hall-effect IC 22a.

Due to the above constitution, a state of rotation of the rotating machine 40 is detected when the Hall-effect IC 22a, which is arranged between the electro-magnetic clutch 1 and the housing 43, detects a change in the leakage magnetic flux. Due to the foregoing, it is unnecessary to conduct machining for accomplishing detection, and a size of the detector is smaller than that of the conventional detector in which a coil is used. As this detector is not affected by noise, it is unnecessary to arrange another magnetic body such as a magnet. Therefore, it is possible to obtain a high detection accuracy at a low manufacturing cost.

In order to form a leakage magnetic flux path Φ′ between the electro-magnetic clutch 1 and the housing 43, the through-bolt 63 to fix the housing 43 is utilized. Due to this constitution, it becomes unnecessary to form the leakage magnetic flux path Φ′ between the electro-magnetic clutch 1 and the housing 43. Therefore, the manufacturing cost can be reduced.

The Hall-effect IC 22a is molded by the sensor holder portion 22b so that it can be formed into a cap-shape. Then, the Hall-effect IC 22a covers the through-bolt 63 and is held by the electro-magnetic clutch 1 being pressed to it. Due to this constitution, it becomes unnecessary to provide a part for holding the sensor. Therefore, the manufacturing cost can be reduced. Further, it is possible to protect the Hall-effect IC 22a from the external environment and from shock from the outside.

In the case where a predetermined pulsation is not generated in the signal voltage sent from the Hall-effect IC 22a in a condition in which the rotary shaft 48 is to be rotated, ECU 20 judges that the device is locked up. Then, ECU 20 shuts off an electric power supply sent to the electromagnetic clutch 1 so as to prevent the belt 31 from being damaged. Due to the foregoing, the detection value concerned can be used for the rotation detecting mechanism. Further, in the same manner as that of the conventional rotating speed detecting means, the detection value concerned can be used for the lock-up-detecting means by judging whether or not a detected change in the signal corresponds to the rotating speed.

The rotating machine 40 is a compressor. Due to the foregoing, it can be preferably used for the lock-up-detecting mechanism of the compressor having an electro-magnetic clutch. The lug plate 52 of the swash plate type variable capacity compressor is used for the variable leakage magnetic flux portion 52. The reason is described as follows. When the present invention utilizes the lug plate 52 and a change in the distance to the through-bolt 63 is provided, the variable leakage magnetic flux portion 52 can be easily formed. Due to this, the manufacturing cost can be reduced.

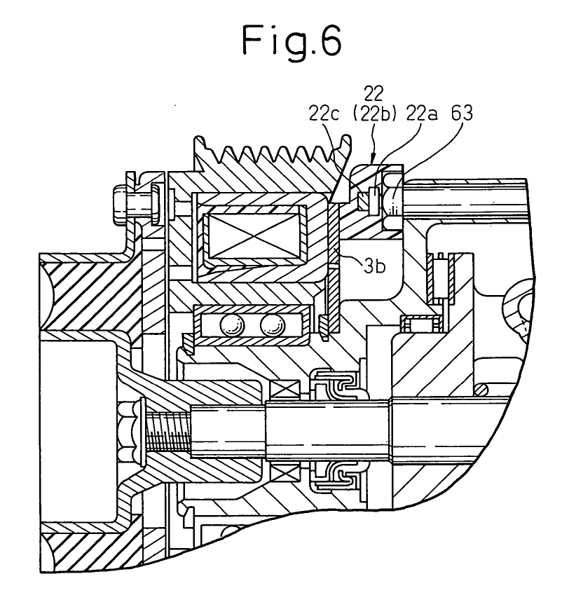

Next, a second embodiment will be explained below. FIG. 6 is a partial sectional view showing an electro-magnetic clutch 1 and a compressor 40 in the second embodiment of the present invention which corresponds to claims 4 and 5. A characteristic point of this second embodiment, which is different from that of the first embodiment, is that an iron piece 22c, which is a magnetic member, is arranged between the Hall-effect IC 22a and the electro-magnetic clutch 1. Due to this structure, even when a weak change in the leakage magnetic flux is caused, the detecting accuracy can be enhanced.

The Hall-effect IC 22a and the iron piece 22c are integrated with each other into one body being molded by the sensor holder portion 22b. Due to this structure, a positional relation between the Hall-effect IC 22a and the iron piece 22c can be stabilized and the detection accuracy can be stabilized. Further, as a plurality of parts can be integrated with each other into one body, the parts can be easily handled. Therefore, the manufacturing cost can be reduced.

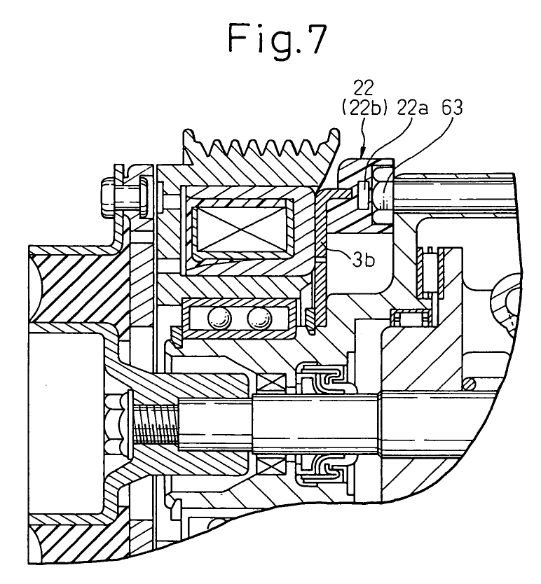

Next, a third embodiment will be explained below. FIG. 7 is a partial sectional view showing an electro-magnetic clutch 1 and a compressor 40 in the third embodiment of the present invention which corresponds to claim 6. A characteristic point of this embodiment, which is different from that of each embodiment described above, is that a portion of the clutch bottom plate 3b composing the electro-magnetic clutch 1 is used for the magnetic body 22c when the portion of the clutch bottom plate 3b is bent. Due to this structure, the portion of the clutch bottom plate is used for both the detection accuracy enhancing member and the holding member. Therefore, the number of parts can be decreased and the manufacturing cost can be reduced.

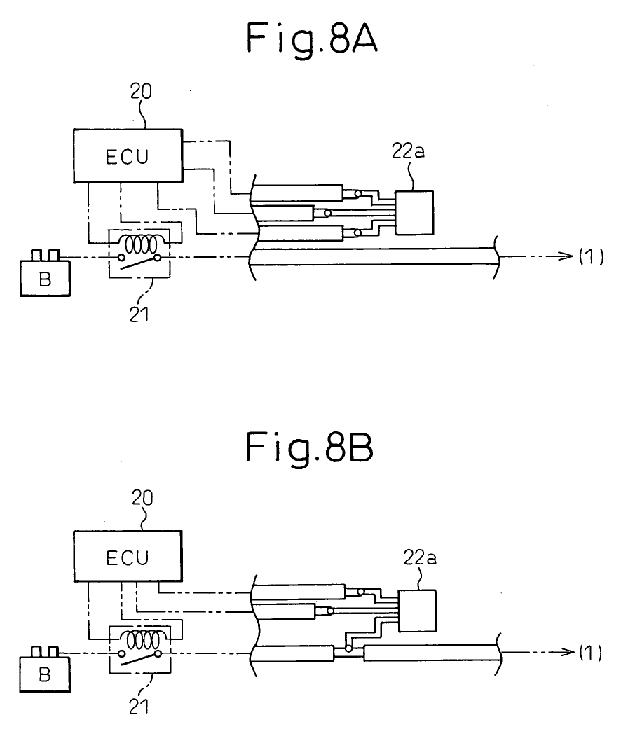

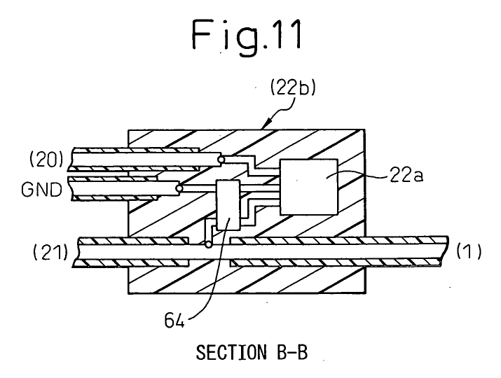

Next, a fourth embodiment will be explained below. FIG. 8A is an electric circuit diagram of this device, wherein FIG. 8A shows a usual connecting method. FIG. 8B is an electric circuit diagram of this device, wherein FIG. 8B shows a connecting method in the fourth embodiment of the present invention which corresponds to claim 7. The Hall-effect IC 22a needs an electric power supply for generating voltage. It is usual that all power supply lines and signal lines of the Hall-effect IC 22a are connected to ECU 20 which is a rotation detecting means. However, the characteristic point of the present embodiment is that the power supply line to the Hall-effect IC 22a uses a line, which is introduced from the battery B via the relay 21 so as to supply electric power to the coil of the electromagnetic clutch 1, in common. Due to this constitution, the number of electric wires laid around ECU 20 can be decreased and the manufacturing cost can be reduced. In this connection, FIG. 8B is a circuit diagram in the case where the operating voltage of the Hall-effect IC 22a is set at 12 V which is the same as that of the electro-magnetic clutch 1. In the case where the operating voltage of the Hall-effect IC 22a is made to be different from that of the electro-magnetic clutch 1, for example, the operating voltage of the Hall-effect IC 22a is made to be 5 V, a regulator 64 for regulating voltage may be interposed at the position shown in FIG. 11.

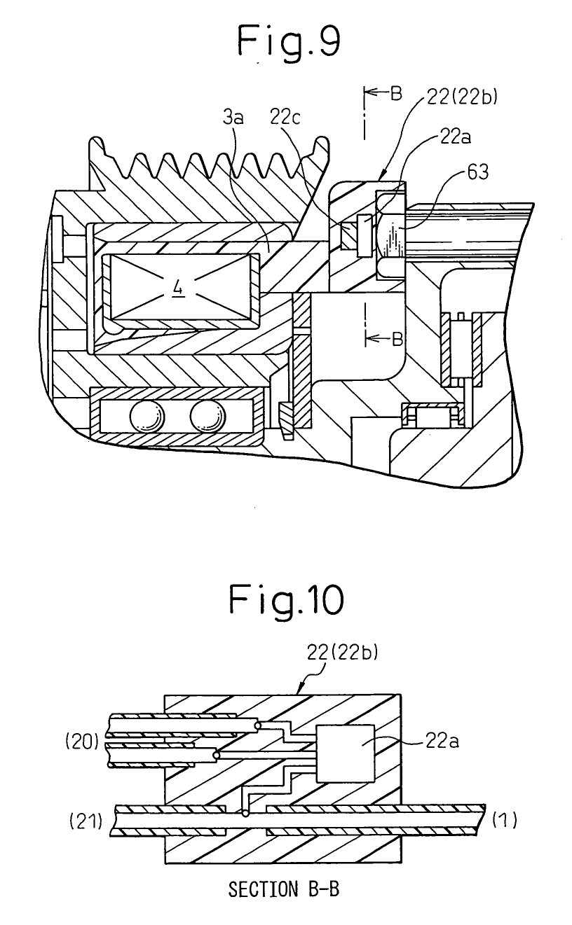

Next, a fifth embodiment will be explained below. FIG. 9 is a partial sectional view showing an electro-magnetic clutch 1 and a compressor 40 of the fifth embodiment of the present invention which corresponds to claims 8 and 9. FIG. 10 is a sectional view taken on line B-B in FIG. 9. A characteristic point of this embodiment, which is different from that of each embodiment described before, is that the Hall-effect IC 22a and the power supply line to the electro-magnetic clutch 1 connected to the Hall-effect IC 22a are molded by the sensor holder 22b into one body. Due to this constitution, a plurality of parts are integrated with each other into one body. Therefore, the handling becomes easy and the manufacturing cost can be reduced.

Further, the sensor holder 22b, in which the Hall-effect IC 22a and the power supply line to the electro-magnetic clutch 1 are molded into one body, is integrated with the electromagnetic clutch 1 into one body by the resin member 3a of the exciting coil portion 4 of the electromagnetic clutch 1. Due to this constitution, when the electromagnetic clutch 1 is incorporated, the Hall-effect IC 22a can be also incorporated. Therefore, the handling can be easily conducted and the manufacturing cost can be reduced.

Finally, another embodiment will be explained below. In the embodiments described above, a state of lock up of the compressor 40 is detected when no pulsation is generated in the output of the Hall-effect IC 22a. However, the following constitution may be adopted. A pulse signal is picked up by using the output of the Hall-effect IC 22a and the comparison voltage. The rotating speed is compared with the engine rotating speed by ECU 20 so as to detect a state of lock up of the compressor 40.

While the invention has been described by reference to specific embodiments chosen for purposes of illustration, it should be apparent that numerous modifications could be made thereto by those skilled in the art without departing from the basic concept and scope of the invention.

Claims:

1. A rotating machine having an electro-magnetic clutch, which is a rotating machine, the rotary shaft of which receives torque from a prime mover via the electro-magnetic clutch, comprising:
a leakage magnetic flux path formed between the electromagnetic clutch and a housing of the rotating machine via the rotary shaft when a portion of the magnetic flux generated by the electro-magnetic clutch leaks out;
a Hall-effect IC, which is arranged in the leakage magnetic flux path, for detecting an amount of the leakage magnetic flux passing through the Hall-effect IC;
a variable leakage magnetic flux portion which composes a portion of the leakage magnetic flux path and is rotated by the rotary shaft; and
a rotation detecting means for detecting a state of rotation of the rotating machine from a change in the leakage magnetic flux detected by the Hall-effect IC.

2. A rotating machine having an electromagnetic clutch according to claim 1, wherein a fastening screw portion for fixing the housing is utilized for forming the leakage magnetic flux path between the electro-magnetic clutch and the housing.

3. A rotating machine having an electromagnetic clutch according to claim 1, wherein the Hall-effect IC is molded in a resin portion and formed into a cap-shape, so that the Hall-effect IC can cover the fastening screw portion, and the Hall-effect IC is pressed and held by the electromagnetic clutch.

4. A rotating machine having an electro-magnetic clutch according to claim 1, wherein a magnetic body is arranged between the Hall-effect IC and the electro-magnetic clutch.

5. A rotating machine having an electro-magnetic clutch according to claim 4, wherein the Hall-effect IC and the magnetic body are molded in the resin portion and are integrated with each other into one body.

6. A rotating machine having an electro-magnetic clutch according to claim 4, wherein a magnetic plate composing the electro-magnetic clutch is used as the magnetic body.

7. A rotating machine having an electro-magnetic clutch according to claim 1, wherein the Hall-effect IC and the electro-magnetic clutch have an electric power source in common.

8. A rotating machine having an electro-magnetic clutch according to claim 7, wherein the Hall-effect IC and the power supply line to the electro-magnetic clutch, which is connected to Hall-effect IC, are molded in the resin portion and are integrated with each other into one body.

9. A rotating machine having an electromagnetic clutch according to claim 8, wherein the resin portion, in which the Hall-effect IC and the power supply line to the electro-magnetic clutch are molded and integrated with each other into one body, is further integrated, with the electro-magnetic clutch, into one body by the resin member of the exciting coil portion of the electro-magnetic clutch.

10. A rotating machine having an electro-magnetic clutch according to claim 1, wherein the rotation detecting means judges that the rotating machine is in a state of lock up and the rotation detecting means shuts off a power supply to the electro-magnetic clutch in the case where a predetermined pulsation is not caused in a signal voltage sent from the Hall-effect IC under the condition that the rotary shaft is to be rotated.

11. A rotating machine having an electro-magnetic clutch according to claim 1, wherein the rotating machine is a compressor.

12. A rotating machine having an electro-magnetic clutch according to claim 11, wherein a lug plate of a swash plate type variable capacity compressor is used for the variable leakage magnetic flux portion.
